(19) United States
(12) Patent Application Publication
(10) Pub. No.: US 2026/0338383 A1
(43) Pub. Date: Oct. 29, 2026

(54) DRAWER-TYPE MICROWAVE OVEN AND CONTROL METHOD THEREOF

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: Liang Wang FENG, Foshan City (CN); Feng LI, Foshan City (CN); Xiao Qiang CHEN, Foshan City (CN); Xiao Bo WANG, Foshan City (CN); Ren Sheng DENG, Foshan City (CN)

(21) Appl. No.: 19/657,285

(22) Filed: Apr. 24, 2026

(30) Foreign Application Priority Data
Apr. 29, 2025 (CN) 202510553361.7
Apr. 29, 2025 (CN) 202510553466.2

(51) Int. Cl. F24C 7/08; E05F 15/40; F24C 7/02; F24C 15/02

(52) U.S. Cl. CPC F24C 7/08; E05F 15/40; F24C 7/02; F24C 15/023; E05Y 2900/308

(57) ABSTRACT

A drawer-type microwave oven including an oven body, a drawer connected to the oven body, and a motor that drives the drawer in the front-rear direction relative to the oven body. Only one door opening/closing button is provided on the oven body. A control method includes powering on the microwave oven, obtaining the pressing duration of the door opening/closing button, determining whether the pressing duration is greater than a threshold (if no, maintain current state; if yes, proceed), controlling the motor to open/close the drawer, controlling the motor to drive the drawer at a uniform speed throughout the opening and/or closing. In the control method for the microwave oven only one button is needed, reducing the area occupied by buttons and reserving space for functional expansion to not only prevent accidental drawer movement caused by inadvertent touch, ensuring user operation safety, but also improve the motion stability of the drawer.

### CROSS-REFERENCE TO RELATED APPLICATIONS

This application claims priority to Chinese Patent Application No. 202510553466.2 filed with the China National Intellectual Property Administration (CNIPA) on Apr. 29, 2025, and Chinese Patent Application No. 202510553361.7 filed with CNIPA on Apr. 29, 2025,the disclosures of both of which are incorporated herein by reference in their entireties.

### FIELD

The present disclosure relates to the technical field of household appliances, and more specifically, to a drawer-type microwave oven and control method thereof.

### BACKGROUND

In the related art, when a drawer-type microwave oven controls automatic door opening and closing, two buttons are generally provided on the control panel: one is an "open door" button and the other is a "close door" button, which respectively control the automatic opening and automatic closing of the drawer. However, the simultaneous presence of two buttons requires occupying the positions of two buttons. When the functions of the microwave oven are expanded, more function keys need to be added, and the limited area will be unable to meet the demand, thereby significantly constraining the product's upgrade space.

Meanwhile, in the prior art, the control method of the drawer-type microwave oven is simple, and the drawer will open as long as the door opening/closing button is pressed and held, lacking an anti-misoperation mechanism. Users may accidentally trigger the door opening/closing command during daily operation, causing the drawer to open or close unexpectedly. The safety of the drawer during the opening and closing process is relatively poor. In addition, the stability of the drawer during the opening and closing process is also relatively poor.

In view of this, the present disclosure is hereby proposed.

### SUMMARY

The purpose of the present disclosure is to provide a drawer-type microwave oven and a control method therefor, to solve the problems in the prior art where the drawer-type microwave oven has two buttons existing simultaneously, requiring two button positions to be occupied, and when the functions of the microwave oven are expanded, insufficient buttons will significantly constrain the product upgrade space; meanwhile, the control method for the drawer-type microwave oven is simple, where the drawer will open as long as the door opening/closing button is pressed and held, lacking an anti-misoperation mechanism, users may accidentally trigger the door opening/closing command during daily operation, causing the drawer to open or close unexpectedly, resulting in poor safety during the drawer opening and closing process, and furthermore, there is also the problem of poor stability during the drawer opening and closing process.

To achieve the above purpose, the technical solution of the present disclosure is implemented as follows:
A control method for a drawer-type microwave oven, wherein the drawer-type microwave oven comprises an oven body, a drawer, and a motor, the drawer is connected to the oven body, the motor is configured to drive the drawer to move in a front-rear direction relative to the oven body, and only one door opening/closing button is provided on the oven body;

The control method comprises the following steps:
S1: powering on the drawer-type microwave oven;
S2: acquiring a pressing duration t1 of the door opening/closing button;
S3: determining whether the pressing duration t1 > a first preset time threshold T1, if yes, proceeding to step S4, if no, maintaining the current state;
S4: controlling the motor to open or close the drawer; controlling the motor to drive the drawer to move at a uniform speed throughout the entire opening and/or closing process.

Further, step S2 includes the following steps:
S21: determine whether the child lock is set; if yes, maintain the current state; if no, proceed to step S22;
S22: determine whether the door opening/closing button is being pressed; if yes, proceed to step S23; if no, reset the timer to zero;
S23: the timer starts timing;
S24: obtain the pressing duration t1 of the door opening/closing button.

Further, step S4 includes the following steps:
S41: setting the initial count of the counter to 0;
S42: determining whether the drawer is closed; if yes, proceeding to step S43; if no, proceeding to step S44;
S43: controlling the motor to open the drawer and setting the count of the counter to 0;
S44: determining whether the drawer is at the maximum door opening stroke; if yes, proceeding to step S45; if no, proceeding to step S46;
S45: controlling the motor to close the drawer and setting the count of the counter to 1;
S46: determining whether the count of the counter is 1; if yes, proceeding to step S47; if no, closing the drawer;
S47: closing the drawer;
S48: opening the drawer.

Further, the value range of the first preset time threshold T1 is: [0.4, 10], and the unit of the first preset time threshold T1 is s.

Further, the first preset time threshold T1 is 0.5s.

Further, the control method further includes the following steps:
S5: determining whether a stop command is received, if yes, proceeding to step S8, if no, proceeding to step S6;
S6: acquiring the operation time t2 of the motor;
S7: determining whether the operation time t2 of the motor > a second preset time threshold T2, if yes, proceeding to step S8, if no, maintaining the current state;
S8: controlling the motor to stop moving.

Further, the value range of the second preset time threshold T2 is: (0, 10], and the unit of the second preset time threshold T2 is s.

Further, rollers are respectively provided on the left and right sides of the drawer, and step S47 includes the following steps:
S471: obtaining an angle α between the rotation center axis of the roller and a horizontal plane;
S472: determining whether the angle α between the rotation center axis of the roller and the horizontal plane is 0; if yes, proceeding to step S474; if no, proceeding to step S473;
S473: the speed v of the drawer during the entire closing process is given by v = v0 - k1×α，wherein v0 represents a preset initial speed, k1 denotes a first preset coefficient;
S474: obtaining a ratio b of the axial width K of the roller to the radial diameter of the roller;
S475: determining whether the ratio b of the axial width K of the roller to the radial diameter of the roller ≥ 1; if yes, proceeding to step S476; if no, proceeding to step S477;
S476: the speed v of the drawer during the entire closing process is given by v = v0 + k2×b，wherein k2 denotes a second preset coefficient;
S477: the speed v of the drawer during the entire closing process is given by v = v0.

Further, step S48 includes the following steps:
S481: obtaining the angle α between the rotation center axis of the roller and the horizontal plane;
S482: determining whether the angle α between the rotation center axis of the roller and the horizontal plane is 0; if yes, proceeding to step S484; if no, proceeding to step S483;
S483: the speed v of the drawer throughout the entire opening process is given by v = v0 - k1×α;
S484: obtaining the ratio b of the axial width K of the roller to the radial diameter of the roller;
S485: determining whether the ratio b of the axial width K of the roller to the radial diameter of the roller ≥ 1; if yes, proceeding to step S486; if no, proceeding to step S487;
S486: the speed v of the drawer throughout the entire opening process is given by v = v0 + k2×b;
S487: the speed v of the drawer throughout the entire opening process is given by v = v0.

A second aspect of the present disclosure provides a drawer-type microwave oven, wherein the drawer-type microwave oven uses the control method for a drawer-type microwave oven as described above.

Further, the oven body includes a cavity, a sensing assembly is disposed on a front side of the cavity, and a trigger assembly is disposed on a rear side of the drawer; when the drawer moves to the maximum door opening stroke position, the trigger assembly is capable of applying magnetic force to or projecting light onto the sensing assembly for triggering the sensing assembly.

Further, the trigger assembly has a magnetic structure or a light source component, and the sensing assembly has a corresponding reed switch sensor or optocoupler sensor.

Further, a locking slot is disposed on the oven body, a microswitch is disposed within the locking slot, the drawer includes a door body, an elastic door hook is disposed on the door body, the elastic door hook includes a hook portion, and the hook portion engaging with or separating from the locking slot enables the microswitch to be switched on or off.

Further, an elastic member is disposed on the door body, one end of the elastic member is connected to the elastic door hook, and the other end of the elastic member is connected to the door body.

Further, the cavity has a cooking chamber therein, the drawer is connected to the cavity in a manner enabling forward and backward movement within the cooking chamber, rollers are respectively disposed on left and right sides of the drawer, the rollers are in rolling contact with a bottom wall of the cavity and are capable of being in clearance fit or rolling contact with side walls of the cavity; an angle between a rotation center axis of the rollers and a horizontal plane is α, where α is 0°-60°.

Further, in a direction of the rotation center axis of the roller, one side of the roller is provided with a first conical surface, and the other side is provided with a second conical surface, the first conical surface is in rolling contact with the side wall, and the second conical surface is in clearance fit or rolling contact with the bottom wall.

Further, α is 30°-60°.

Further, a ratio of an axial width K of the roller to a radial diameter of the roller is b, where b≥1.

Further, b is 1.5-3.5.

Compared with the prior art, the drawer-type microwave oven and control method of the present disclosure have the following beneficial effects:
1) In the drawer-type microwave oven and control method of the present disclosure, only one door opening/closing button is provided on the drawer-type microwave oven, reducing the area occupied by buttons and reserving space for functional expansion.
2) In the drawer-type microwave oven and control method of the present disclosure, when the pressing duration t1 > the first preset time threshold T1, the motor is controlled to open or close the drawer, avoiding accidental drawer movement caused by inadvertent touch and ensuring user operation safety.
3) In the drawer-type microwave oven and control method of the present disclosure, when the drawer moves to the maximum door opening stroke position, the trigger assembly can apply magnetic force to or project light onto the sensing assembly to trigger the sensing assembly; by triggering the sensing assembly through the trigger assembly, the movement of the drawer can be stopped in a timely manner, preventing the door-opening motor from continuing to operate and eliminating damage to the motor or related components caused by excessive door opening; the trigger assembly of the present application triggers the sensing assembly in a non-contact manner, which can effectively improve sensing accuracy while preventing any collision or friction between the two as the drawer moves, effectively avoiding situations such as excessive impact or friction of sensing components caused by excessively fast drawer movement speed, which is conducive to ensuring the structural integrity and use safety of the trigger assembly and sensing assembly respectively, and helps to extend their service life.
4) In the drawer-type microwave oven and control method of the present disclosure, the elastic door hook and the elastic member cooperate with each other, and the connection hole is disposed below the rotation hole, serving multiple functions: first, improving the operational smoothness of door opening and closing; second, after the drawer is pulled out, the elastic member pulls the elastic door hook to reset, enabling the door body to automatically spring back and reducing user operations; third, reducing the impact sound between the door body and the oven body, which not only improves use comfort but also avoids mechanical wear caused by hard collisions, reducing equipment wear and extending service life; fourth, the pulling direction of the elastic member forms a reasonable torque with the rotation center of the elastic door hook, reducing lateral offset and improving locking stability; fifth, the installation path of the elastic member is shorter, reducing the assembly difficulty of the elastic member.
5) In the drawer-type microwave oven and control method of the present disclosure, controlling the motor to drive the drawer to move at a uniform speed throughout the entire opening and/or closing process serves multiple functions: first, avoiding the vibration, jerking, or sudden acceleration/deceleration that may occur in traditional non-constant-speed control, improving the stability of the drawer during the door opening and closing process, making operation more natural and comfortable; second, moving at a uniform speed can avoid items inside the microwave oven (such as tableware and food) from tipping over or colliding due to inertia caused by sudden speed changes, improving safety; third, constant-speed movement reduces friction and stress concentration on components such as slide rails and gears, extending the service life of the drawer and motor; fourth, motor efficiency is higher under constant-speed movement, reducing energy waste caused by frequent starting/stopping or speed changes; fifth, the control method is simple, reducing development and maintenance costs.

### BRIEF DESCRIPTION OF THE DRAWINGS

FIG. 1 is a first perspective structural schematic diagram of a drawer-type microwave oven according to an embodiment of the present disclosure;

FIG. 2 is a second perspective structural schematic diagram of a drawer-type microwave oven according to an embodiment of the present disclosure;

FIG. 3 is a third perspective structural schematic diagram of a drawer-type microwave oven according to an embodiment of the present disclosure;

FIG. 4 is a fourth perspective structural schematic diagram of a drawer-type microwave oven according to an embodiment of the present disclosure;

FIG. 5 is a partial enlarged view at location A in FIG. 4 according to the embodiment of the present disclosure;

FIG. 6 is an exploded structural diagram of the sensing assembly and trigger assembly near the maximum door opening stroke of a drawer-type microwave oven according to an embodiment of the present disclosure;

FIG. 7 is a perspective structural schematic diagram of a second mounting bracket of a drawer-type microwave oven according to an embodiment of the present disclosure;

FIG. 8 is a fifth perspective structural schematic diagram of a drawer-type microwave oven according to an embodiment of the present disclosure;

FIG. 9 is an enlarged perspective structural schematic diagram at location A in FIG. 8;

FIG. 10 is a first perspective structural schematic diagram of an elastic door hook of a drawer-type microwave oven according to an embodiment of the present disclosure;

FIG. 11 is a second perspective structural schematic diagram of an elastic door hook of a drawer-type microwave oven according to an embodiment of the present disclosure;

FIG. 12 is a cross-sectional schematic diagram of the interior of the cavity of a drawer-type microwave oven according to an embodiment of the present disclosure;

FIG. 13 is a partial enlarged view at location A in FIG. 12 according to the embodiment of the present disclosure;

FIG. 14 is a partial schematic diagram (in exploded state) of the roller at the junction of the bottom wall and side wall of the cavity according to the embodiment of the present disclosure;

FIG. 15 is a structural schematic diagram of the drawer according to the embodiment of the present disclosure;

FIG. 16 is another structural schematic diagram of the drawer according to the embodiment of the present disclosure.

### DESCRIPTION OF REFERENCE NUMERALS

100. drawer-type microwave oven; 1. oven body; 10. locking slot; 11. microswitch; 12. inclined surface portion; 2. cavity; 21. front panel; 22. side wall; 23. transition inclined surface; 24. bottom wall; 3. drawer; 4. rail assembly; 41. fixed rail; 42. movable rail; 420. tail end; 421. slot opening; 422. positioning hole; 423. first fixing hole; 43. connecting rail; 451. mounting plate; 46. roller; 461. first conical surface; 462. second conical surface; 463. wheel peripheral surface; 5. door body; 51. elastic door hook; 52. elastic member; 511. hook portion; 512. rotation hole; 513. connection hole; 514. first reinforcing protrusion; 515. second reinforcing protrusion; 516. third reinforcing protrusion; 517. fourth reinforcing protrusion; 6. sensing assembly; 61. first mounting bracket; 62. sensing element; 7. trigger assembly; 71. second mounting bracket; 711. mounting portion; 712. first arm; 713. second arm; 714. positioning column; 715. second fixing hole; 72. trigger element; 8. carrier frame; 9. door opening/closing button.

### DETAILED DESCRIPTION OF EMBODIMENTS

In order to facilitate understanding of the technical means, objectives, and effects of the present disclosure, the embodiments of the present disclosure are described in detail below with reference to specific drawings.

It should be noted that all terms indicating direction and position in the present disclosure, such as "upper," "lower," "left," "right," "front," "rear," "vertical," "horizontal," "inner," "outer," "top," "bottom," "transverse," "longitudinal," "center," etc., are only used to explain the relative positional relationships and connection conditions between components in a specific state (as shown in the drawings), and are only for the convenience of describing the present disclosure, rather than requiring the present disclosure to be constructed and operated in a specific orientation. Therefore, these terms should not be construed as limitations on the present disclosure. Additionally, descriptions involving "first," "second," etc. in the present disclosure are only for descriptive purposes and should not be construed as indicating or implying relative importance or implicitly specifying the quantity of the indicated technical features.

In the description of the present disclosure, unless otherwise explicitly specified and limited, the terms "mounted," "connected," and "coupled" should be understood in a broad sense. For example, they may refer to fixed connections, detachable connections, or integral connections; they may refer to mechanical connections; they may refer to direct connections or indirect connections through an intermediate medium; and they may refer to internal communication between two elements. For those of ordinary skill in the art, the specific meanings of the above terms in the present disclosure can be understood according to specific circumstances.

In the description of this specification, descriptions referring to terms such as "one embodiment," "some embodiments," "illustrative embodiments," "examples," "specific examples," or "some examples" mean that specific features, structures, materials, or characteristics described in connection with the embodiment or example are included in at least one embodiment or example of the present disclosure. In this specification, the schematic representations of the above terms do not necessarily refer to the same embodiment or example. Furthermore, the specific features, structures, materials, or characteristics described may be combined in a suitable manner in any one or more embodiments or examples.

The present disclosure will be described in detail below with reference to the accompanying drawings and in conjunction with the embodiments.

### Embodiment 1

In the prior art, the drawer-type microwave oven 100 has two buttons existing simultaneously, which requires occupying positions for two buttons. When the functions of this microwave oven are expanded, insufficient buttons will significantly constrain product upgrade space. Meanwhile, the control method of the drawer-type microwave oven 100 is simple, as the drawer opens simply by pressing and holding the door opening/closing button 9, lacking an anti-misoperation mechanism. Users may accidentally trigger door opening/closing commands during daily operation, causing the drawer 3 to open or close unexpectedly, resulting in poor safety of the drawer 3 during opening and closing processes.

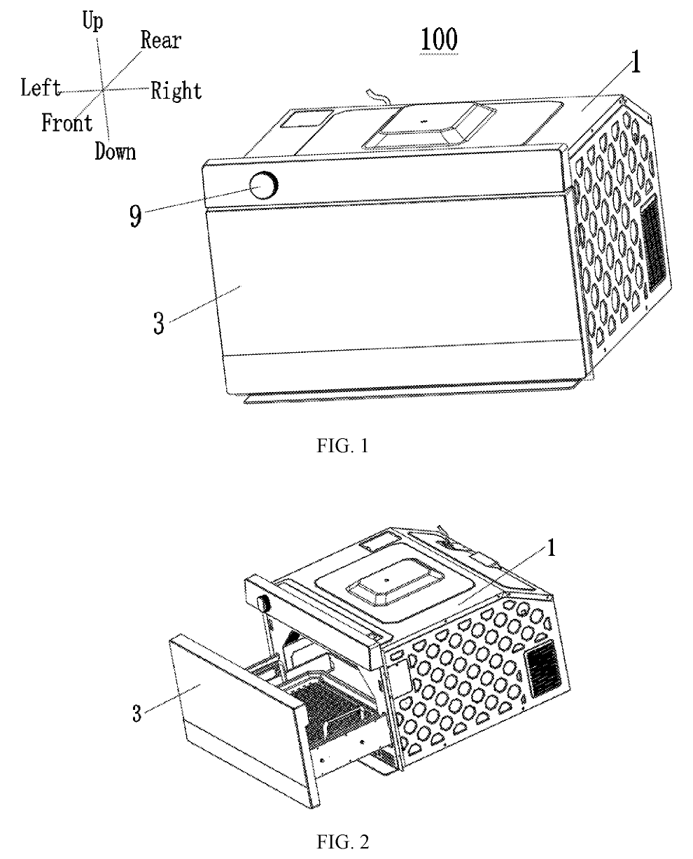

This embodiment proposes a control method for a drawer-type microwave oven. As shown in FIGS. 1 -11, the drawer-type microwave oven 100 includes an oven body 1, a drawer 3, and a motor. The drawer 3 is connected to the oven body 1, and the motor is used to drive the drawer 3 to move in the front-rear direction relative to the oven body 1. Only one door opening/closing button 9 is provided on the oven body 1.

The control method includes the following steps:
S1: power on the drawer-type microwave oven 100;
S2: obtain the pressing duration t1 of the door opening/closing button 9;
S3: determine whether the pressing duration t1 > a first preset time threshold T1. If yes, proceed to step S4; if no, maintain the current state;
S4: control the motor to open or close the drawer 3.

This embodiment proposes a control method for a drawer-type microwave oven. Only one door opening/closing button 9 is provided on the drawer-type microwave oven 100, reducing the area occupied by buttons and reserving space for function expansion. This embodiment proposes a control method for a drawer-type microwave oven wherein steps S1-S4 are interrelated and inseparable, preventing accidental actions of the drawer 3 caused by misoperation and ensuring user operation safety.

Step S2 includes the following steps:
S21: determine whether the child lock is set; if yes, maintain the current state; if no, proceed to step S22;
S22: determine whether the door opening/closing button 9 is pressed; if yes, proceed to step S23; if no, reset the timer to zero;
S23: start timing;
S24: obtain the pressing duration t1 of the door opening/closing button 9.

Step S21 enhances safety through child lock priority determination; in scenarios where users may accidentally touch the button (such as during children's play or cleaning), the child lock function completely disables button operations, preventing accidental opening and closing of the drawer 3. Setting the child lock status as the highest priority determination condition ensures that the safety mechanism takes precedence over other functional logic, meeting users' core requirements for home appliance safety. Steps S22-S24 implement anti-misoperation design, where timing only begins when the door opening/closing button 9 is actually pressed, avoiding false triggering caused by user's finger hovering or slight contact; if the button is not pressed, the timer automatically resets to zero, preventing misidentification of short presses as long presses and improving system reliability.

Step S4 includes the following steps:
S41: set the initial count of the counter to 0;
S42: determine whether the drawer 3 is closed; if yes, proceed to step S43; if no, proceed to step S44;
In the present disclosure, a locking slot 10 is provided on the oven body 1, a microswitch 11 is provided within the locking slot 10, the drawer 3 includes a door body 5, an elastic door hook 51 is provided on the door body 5, the elastic door hook 51 includes a hook portion 511, and the engagement or disengagement of the hook portion 511 with the locking slot 10 causes the microswitch 11 to be connected or disconnected. Whether the drawer 3 is closed is detected through the elastic door hook 51, the locking slot 10, and the microswitch 11. When the hook portion 511 engages with the locking slot 10, the microswitch 11 is connected, and the drawer 3 is closed; when the hook portion 511 disengages from the locking slot 10, the microswitch 11 is disconnected, and the drawer 3 is not closed; see embodiment 3 for details.
S43: control the motor to open the drawer 3 and set the count of the counter to 0;
S44: determine whether the drawer 3 is at the maximum door opening stroke; if yes, proceed to step S45; if no, proceed to step S46;
In the present disclosure, whether the drawer 3 is at the maximum door opening stroke is detected through the sensing assembly 6 and the trigger assembly 7. When the drawer 3 moves to the maximum door opening stroke position, the trigger assembly 7 is capable of applying magnetic force to or projecting light onto the sensing assembly 6 to trigger the sensing assembly 6; see embodiment 2 for details.
S45: control the motor to close the drawer 3 and set the count of the counter to 1;
S46: determine whether the count of the counter is 1; if yes, proceed to step S47; if no, close the drawer 3;
S47: close the drawer 3;
S48: open the drawer 3.

As a preferred example of the present application, the value range of the first preset time threshold T1 is: [0.4, 10], and the first preset time threshold T1 may take any value within [0.4, 10], with the unit of the first preset time threshold T1 being s. The first preset time threshold T1 may be 0.4s, the first preset time threshold T1 may also be 1.5s, and the first preset time threshold T1 may further be 10s, without being limited thereto.

As a preferred example of the present application, in this embodiment, the first preset time threshold T1 is 0.5s.

### Embodiment 2

In the prior art, the drawer 3 of a drawer-type microwave oven may undergo significant changes at different stages during the movement process, the drawer 3 sways left and right during the movement process, and the stability of the drawer 3 during the movement process is poor; speed variations cause items inside the microwave oven (such as tableware and food) to tip over or collide due to inertia, resulting in low safety.

In order to solve the above technical problems, in step S4, the motor is controlled to drive the drawer 3 to move at a uniform speed throughout the entire opening and/or closing process.

According to the control method for a drawer-type microwave oven described in this embodiment, the motor is controlled to drive the drawer 3 to move at a uniform speed throughout the entire opening and/or closing process: firstly, the drawer 3 moves at a uniform speed throughout the entire door opening and closing process, avoiding inertial impact caused by acceleration changes, reducing noise and vibration, and improving the movement stability of the drawer 3; secondly, moving at a uniform speed can avoid items inside the microwave oven (such as tableware and food) from tipping over or colliding due to inertia caused by speed variations, improving safety; thirdly, mechanical wear caused by inertial impact is reduced, extending the service life of components such as the drawer 3; fourthly, the motor operates more efficiently under uniform speed movement, reducing energy waste caused by frequent starting/stopping or speed changes; fifthly, the control logic is simple, without requiring complex acceleration/deceleration algorithms, the motor only needs to maintain a constant rotational speed, reducing the complexity and development cost of the control system.

As a preferred example of the present application, the control method includes:
Controlling the motor to drive the drawer 3 to move at a uniform speed throughout the entire opening and closing process.
In the control method for a drawer-type microwave oven described in the present embodiment, the drawer 3 moves at a uniform speed throughout the entire opening and closing process, serving multiple functions: first, it avoids the shaking, jerking, or sudden acceleration/deceleration that may occur in traditional non-uniform speed control, improving the stability of the drawer 3 during the door opening and closing process, making the operation more natural and comfortable; second, moving at a uniform speed can prevent items inside the microwave oven (such as tableware and food) from tipping over or colliding due to inertia caused by sudden speed changes, improving safety; third, uniform speed movement reduces friction and stress concentration on components such as slide rails and gears, extending the service life of the drawer 3 and the motor; fourth, the motor operates more efficiently at uniform speed, reducing energy waste caused by frequent starting/stopping or speed changes; fifth, the control method is simple, reducing development and maintenance costs.

Specifically, the control method further includes the following steps:
S5. determining whether a stop command has been received; if yes, proceeding to step S8; if no, proceeding to step S6;
S6. acquiring the operation time t2 of the motor;
S7. determining whether the operation time t2 of the motor > a second preset time threshold T2; if yes, proceeding to step S8; if no, maintaining the current state;
S8. controlling the motor to stop moving.

Steps S5 to S8 are interrelated and inseparable. Through the dual mechanism of real-time command detection and timeout threshold protection, they exhibit excellent performance in terms of safety, stability, energy efficiency, and cost-effectiveness. Step S5 responds to the stop command in real time; when a user triggers an emergency stop, the system can immediately respond and stop the motor, preventing accidents from escalating and improving safety. In step S7, the operation time t2 of the motor is limited by the second preset time threshold T2; if the motor continues to run beyond the second preset time threshold T2 due to a fault (such as an infinite program loop or mechanical jamming), the system automatically stops, preventing overheating or damage, which not only reduces ineffective energy consumption but also further improves safety.

Specifically, the second preset time threshold T2 is a preset value and is not specifically limited.

As a preferred example of the present application, the value range of the second preset time threshold T2 is: (0, 20], and the second preset time threshold T2 may take any value within (0, 20], with the unit of the second preset time threshold T2 being s. The second preset time threshold T2 may be 0.5s, the second preset time threshold T may also be 2s, the second preset time threshold T2 may also be 10s, and the second preset time threshold T2 may further be 20s, but is not limited thereto.

As a preferred example of the present application, in this embodiment, the second preset time threshold T2 is 5s.

### Embodiment 3

During use of existing drawer-type microwave ovens 100, due to defects in improper configuration of structural components for controlling the maximum door opening stroke, there exists a certain lag in the maximum door opening stroke, causing the motor to continue operating after the drawer 3 has reached the maximum door opening stroke, which increases the risk of damage to the motor or other door-opening related components.

To solve the problem of improper configuration of structural components for controlling the maximum door opening stroke in existing drawer-type microwave ovens 100, this embodiment proposes a drawer-type microwave oven 100, wherein the drawer-type microwave oven 100 uses a control method for a drawer-type microwave oven as described in Embodiment 1 and Embodiment 2.

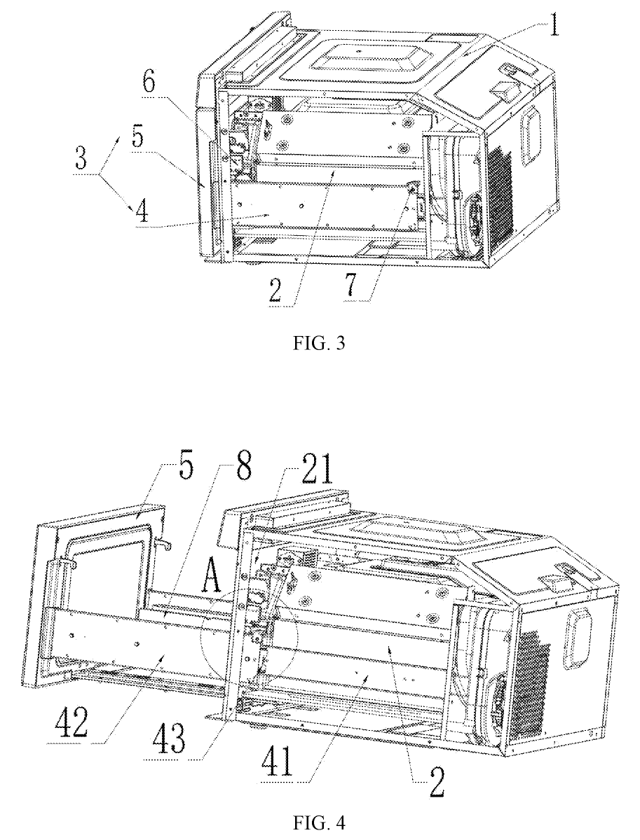

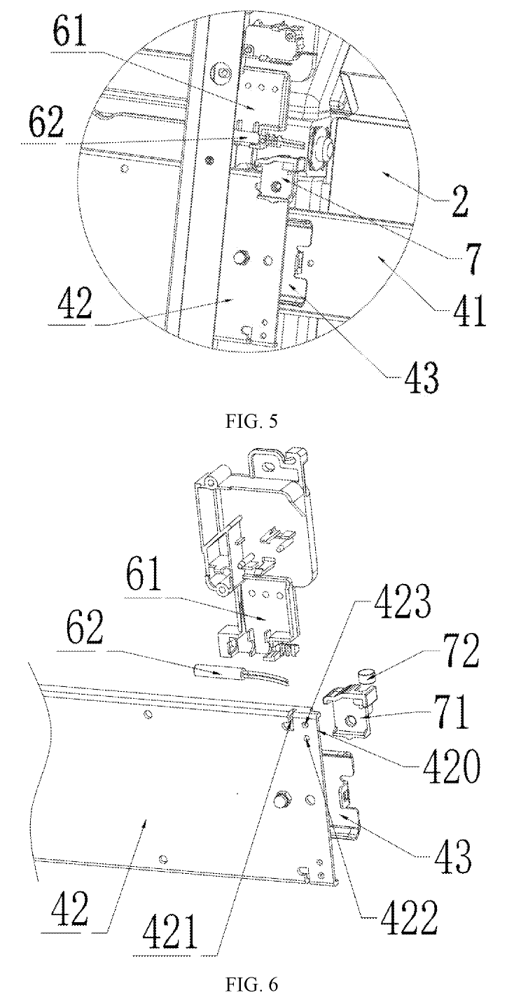

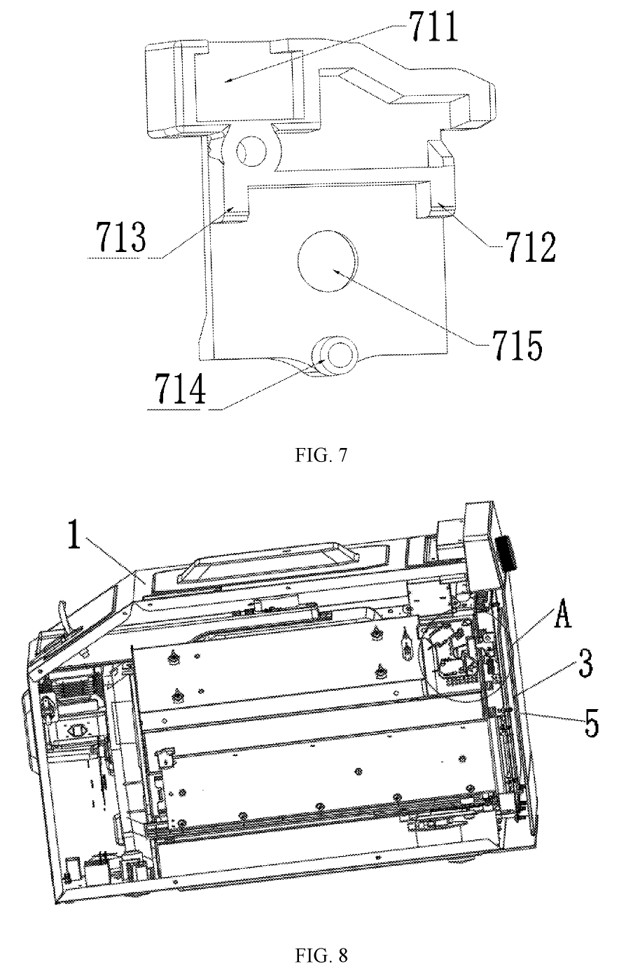

As shown in FIGS. 3 - 7, the drawer-type microwave oven 100 includes an oven body 1, a drawer 3, and a motor, wherein the drawer 3 is connected to the oven body 1, the motor is used for driving the drawer 3 to move in the front-rear direction relative to the oven body 1, the oven body 1 includes a cavity 2, a sensing assembly 6 is provided on the front side of the cavity 2, and a trigger assembly 7 is provided on the rear side of the drawer 3; when the drawer 3 moves to the maximum door opening stroke position, the trigger assembly 7 is capable of applying magnetic force to or projecting light onto the sensing assembly 6, for triggering the sensing assembly 6.

It should be noted that the maximum door opening stroke is the position corresponding to the maximum distance that the drawer 3 moves forward in the cooking device.

Therefore, on the basis of maintaining the structure of a conventional drawer-type microwave oven 100, the present application only requires additionally providing a sensing assembly 6 and a trigger assembly 7 at corresponding positions, such that when the drawer 3 moves to the maximum door opening stroke, the trigger assembly 7 triggers the sensing assembly 6, thereby timely stopping the movement of the drawer 3, preventing the door-opening motor from continuing to operate, and eliminating damage to the motor or related components caused by excessive door opening.

Meanwhile, the trigger assembly 7 of the present application triggers the sensing assembly 6 in a non-contact manner, which can effectively improve sensing accuracy while ensuring that no collision or friction occurs between the two as the drawer 3 moves, effectively avoiding situations such as excessive impact and friction of sensing components caused by excessively fast movement speed of the drawer 3, which is conducive to ensuring the structural integrity and use safety of the trigger assembly 7 and the sensing assembly 6 respectively, and helps to improve their service life.

Preferably, the trigger assembly 7 has a magnetic structure or a light source component, and the sensing assembly 6 has a corresponding reed switch sensor or optocoupler sensor.

The drawer 3 includes a door body 5, a carrier frame 8, and a rail assembly 4. The door body 5 is connected to the carrier frame 8. The rail assembly 4 includes a fixed rail 41 and a movable rail 42. The fixed rail 41 is connected to the cavity 2. The movable rail 42 is connected to the door body 5 and/or the carrier frame 8. The movable rail 42 is connected to the fixed rail 41 and can slide along the fixed rail 41, thereby enabling the drawer 3 to move relative to the cavity 2, realizing the extension and retraction of the drawer 3. Wherein, the fixed rail 41 has a sliding groove structure, and the movable rail 42 can slide within the sliding groove. The rail assembly 4 further includes a connecting rail 43, and the connecting rail 43 is disposed between the fixed rail 41 and the movable rail 42, wherein the width of the connecting rail 43 does not exceed the sliding groove width of the fixed rail 41, such that the connecting rail 43 is located within the sliding groove, and the movable rail 42 wraps around the outside of the connecting rail 43, with the connecting rail 43 driving the movable rail 42 to slide.

A front panel 21 is provided on the front side of the cavity 2. The sensing assembly 6 is connected to the front panel 21, and/or the sensing assembly 6 is connected to a side of the cavity 2 close to the front panel 21. Preferably, the sensing assembly 6 includes a first mounting bracket 61 and a sensing element 62. The sensing element 62 is detachably connected to the first mounting bracket 61. The first mounting bracket 61 is detachably connected to the front panel 21, thereby facilitating disassembly and maintenance of the sensing assembly 6 while ensuring stable installation of the sensing assembly 6. Specifically, the first mounting bracket 61 is provided with a snap-fit slot, and the sensing element 62 can be snap-fitted with the snap-fit slot; the first mounting bracket 61 is provided with snap claws and screw holes, snap-fitted with the front panel 21 through the snap claws, and further secured to the front panel 21 through fasteners. Wherein, the sensing element 62 may be a reed switch sensor or a light sensor.

The trigger assembly 7 is connected to a side of the carrier frame 8 remote from the door body 5, and/or the trigger assembly 7 is connected to a side of the movable rail 42 remote from the door body 5. Preferably, the trigger assembly 7 includes a second mounting bracket 71 and a trigger element 72. The trigger element 72 is detachably connected to the second mounting bracket 71. The second mounting bracket 71 is detachably connected to a side of the movable rail 42 remote from the door body 5, facilitating disassembly and maintenance of the trigger assembly 7 while ensuring stable installation of the trigger assembly 7. Wherein, the trigger element 72 may be a magnet or a light emitter.

The second mounting bracket 71 is provided with a mounting portion 711, and the trigger member 72 is snap-fitted with the mounting portion 711; the movable rail 42 is provided with a slot opening 421 and a first fixing hole 423, the second mounting bracket 71 is provided with a second fixing hole 715 and is provided with a first arm 712 on the side facing the movable rail 42, the first arm 712 is capable of passing through the slot opening 421 and snap-fitting with the slot opening 421, and the second fixing hole 715 and the first fixing hole 423 are capable of being assembled through fasteners. This ensures the assembly stability of the entire trigger assembly 7, and also reduces the risk of the trigger assembly 7 becoming loose or falling off during the movement of the drawer 3.

The end of the movable rail 42 away from the door body 5 is designated as the tail end 420, the second mounting bracket 71 is provided with a second arm 713 on the side facing the movable rail 42, and the second arm 713 abuts against the tail end 420. Thus, on the basis of the first snap-fit relationship formed between the first arm 712 and the slot opening 421, by further providing the second arm 713, a snap-fit space is also formed between the first arm 712 and the second arm 713, forming a second snap-fit relationship with the movable rail 42 at the tail end 420, which helps to further improve the assembly reliability of the entire trigger assembly 7.

On the basis of this structure, in order to improve the assembly convenience of the second mounting bracket 71 and the movable rail 42, the second mounting bracket 71 is provided with a positioning column 714 on the side facing the movable rail 42, and the movable rail 42 is provided with a positioning hole 422 corresponding to the positioning column 714. Thus, when assembling the second mounting bracket 71 with the movable rail 42, it is only necessary to first insert the positioning column 714 into the positioning hole 422 and bring the second arm 713 into contact with the tail end 420, and then force can be directly applied to the second mounting bracket 71 to cause the first arm 712 to enter the slot opening 421, thereby easily completing the two snap-fit relationships between the second mounting bracket 71 and the movable rail 42 in one operation. At the same time, the first fixing hole 423 and the second fixing hole 715 can also be automatically aligned without secondary adjustment, and without the need for manual support of the second mounting bracket 71, the fasteners can be directly installed toward the first fixing hole 423 and the second fixing hole 715. Accordingly, this structure can effectively improve assembly convenience, and the assembly can be completed by only one person.

In addition, for the drawer 3 of the present application, one, two, or even more rail assemblies 4 may be provided; accordingly, the sensing assembly 6, trigger assembly 7, and related assembly relationships described in the present application may be provided only at any one of the rail assemblies 4. Of course, without considering structural complexity, the sensing assembly 6, trigger assembly 7, and related assembly relationships described in the present application may also be provided at each of the rail assemblies 4.

### Embodiment 4

In the prior art, the door hook itself lacks elasticity, resulting in: first, non-smooth door opening and closing; second, the door body 5 cannot automatically spring back to the closed position, requiring the user to manually push it tight, which increases operational complexity; and third, the rigid collision between the door hook and the oven body 1 causes abnormal noise between the door body 5 and the machine body, which not only reduces user comfort but also increases equipment wear and shortens service life.

In order to solve the above technical problems, as shown in FIGS. 8 -11, the present embodiment proposes a drawer-type microwave oven 100, wherein the drawer-type microwave oven 100 uses a control method for a drawer-type microwave oven as described in Embodiment 1.

The drawer-type microwave oven 100 comprises:
an oven body 1, wherein a locking slot 10 is provided on the oven body 1, and a microswitch 11 is provided within the locking slot 10;
a drawer 3, wherein the drawer 3 is slidably disposed on the oven body 1, the drawer 3 comprises a door body 5, an elastic door hook 51 and an elastic member 52 are provided on the door body 5, one end of the elastic member 52 is connected to the elastic door hook 51, and the other end of the elastic member 52 is connected to the door body 5, forming a lever structure;
the elastic door hook 51 comprises:
a hook portion 511, wherein the hook portion 511 engages with or disengages from the locking slot 10 to cause the microswitch 11 to be conducted or disconnected;
a rotation hole 512, serving as a rotation fulcrum, wherein the rotation hole 512 enables the elastic door hook 51 to rotate about the door body 5, and the elastic door hook 51 is rotatably connected to the door body 5 through the rotation hole 512;
a connection hole 513, wherein the connection hole 513 is used for mounting the elastic member 52, and the connection hole 513 is disposed below the rotation hole 512.

The cooperation between the elastic door hook 51 and the elastic member 52 serves multiple functions: first, the smoothness of door opening and closing operations is improved; second, after the drawer 3 is pulled out, the elastic member 52 pulls the elastic door hook 51 to return to position, enabling the door body 5 to automatically spring back and reducing user operations; third, the impact sound between the door body 5 and the oven body 1 is reduced, which not only improves user comfort but also avoids mechanical wear caused by hard collisions, reduces equipment wear, and extends service life.

Disposing the connection hole 513 below the rotation hole 512 serves multiple functions: first, the pulling direction of the elastic member 52 forms a reasonable torque with the rotation center (rotation hole 512) of the elastic door hook 51, reducing lateral deviation and improving locking stability; second, the pulling direction of the elastic member 52 is consistent with the push-pull direction of the drawer 3, reducing operational resistance and further improving operational smoothness; third, the installation path of the elastic member 52 is shorter, reducing the assembly difficulty of the elastic member 52.

In summary, the present embodiment provides a drawer-type microwave oven 100, wherein the elastic door hook 51 cooperates with the elastic member 52, and the connection hole 513 is disposed below the rotation hole 512, serving multiple functions: first, the smoothness of door opening and closing operations is improved; second, after the drawer 3 is pulled out, the elastic member 52 pulls the elastic door hook 51 to return to position, enabling the door body 5 to automatically spring back and reducing user operations; third, the impact sound between the door body 5 and the oven body 1 is reduced, which not only improves user comfort but also avoids mechanical wear caused by hard collisions, reduces equipment wear, and extends service life; fourth, the pulling direction of the elastic member 52 forms a reasonable torque with the rotation center (rotation hole 512) of the elastic door hook 51, reducing lateral deviation and improving locking stability; fifth, the installation path of the elastic member 52 is shorter, reducing the assembly difficulty of the elastic member 52.

Specifically, the hook portion 511 is disposed on a side away from the door body 5, and the rotation hole 512 and the connection hole 513 are disposed on a side close to and away from the door body 5.

As a preferred example of the present application, as shown in FIGS. 10 and FIG. 11, a first reinforcing protrusion 514 is disposed on the elastic door hook 51, the first reinforcing protrusion 514 extends upward from the elastic door hook 51, and the rotation hole 512 is disposed on the first reinforcing protrusion 514. This arrangement improves the structural strength at the rotation hole 512, thereby improving the rotational stability of the elastic door hook 51.

As a preferred example of the present application, as shown in FIGS. 10 and FIG. 11, a second reinforcing protrusion 515 is disposed on the elastic door hook 51, the second reinforcing protrusion 515 extends downward from the elastic door hook 51, and the rotation hole 512 is disposed on the second reinforcing protrusion 515. This arrangement improves the structural strength at the connection hole 513, thereby improving the connection stability between the elastic door hook 51 and the elastic member 52.

As a preferred example of the present application, as shown in FIG. 10, a third reinforcing protrusion 516 is disposed on the first reinforcing protrusion 514, the third reinforcing protrusion 516 extends in a direction away from the center of the door body 5, and the rotation hole 512 is disposed to penetrate through the third reinforcing protrusion 516. This arrangement further improves the structural strength at the rotation hole 512, thereby further improving the rotational stability of the elastic door hook 51.

As a preferred example of the present application, as shown in FIG. 11, a fourth reinforcing protrusion 517 is disposed on the first reinforcing protrusion 514, the fourth reinforcing protrusion 517 extends in a direction toward the center of the door body 5, and the rotation hole 512 is disposed to penetrate through the fourth reinforcing protrusion 517. This arrangement further improves the structural strength at the rotation hole 512, thereby further improving the rotational stability of the elastic door hook 51.

As a preferred example of the present application, as shown in FIG. 11, the third reinforcing protrusion 516 and the fourth reinforcing protrusion 517 are symmetrically disposed on left and right sides of the first reinforcing protrusion 514. This arrangement improves the balance of structural strength at the rotation hole 512, thereby further improving the rotational balance and stability of the elastic door hook 51.

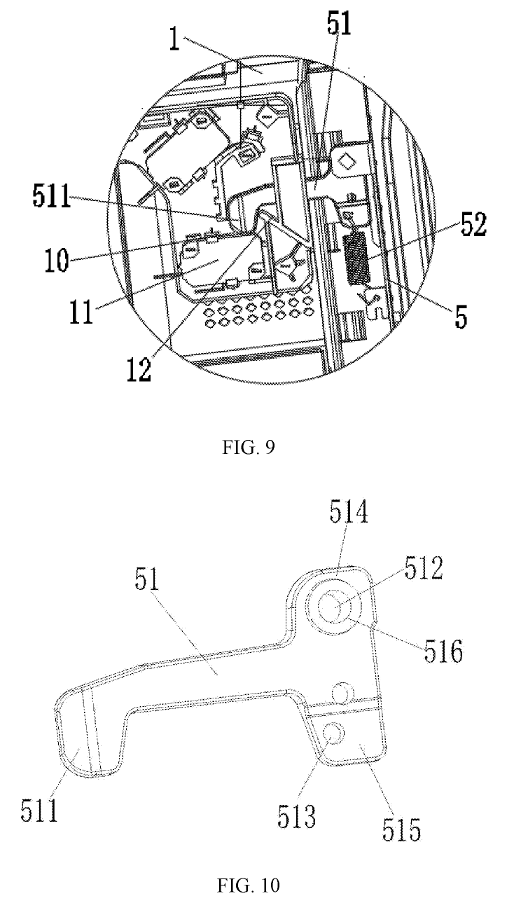

As a preferred example of the present application, as shown in FIG. 9, an inclined surface portion 12 is disposed on the oven body 1, and the locking slot 10 is disposed on a rear side of the inclined surface portion 12.

The inclined surface portion 12 serves as a guiding structure for the elastic door hook 51 to be inserted into the locking slot 10, optimizing operational smoothness. The inclined surface portion 12 prevents hard collision between the elastic door hook 51 and the edge of the locking slot 10, reducing noise while extending component lifespan.

### Embodiment 5

In order to solve the problem that the drawer 3 sways left and right during the opening and closing process, and the stability of the drawer 3 during the opening and closing process is poor, the present embodiment proposes a drawer-type microwave oven, wherein the drawer-type microwave oven uses a control method for a drawer-type microwave oven as described in any one of Embodiment 1 or Embodiment 2.

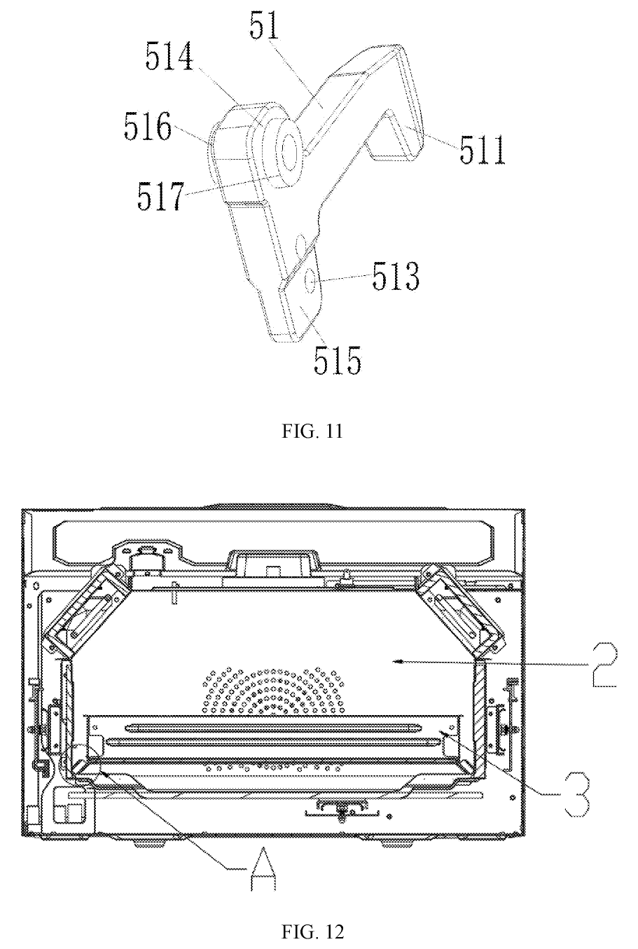

The present embodiment proposes a drawer-type microwave oven. As shown in FIGS. 12 -16, the drawer-type microwave oven includes a cavity 2 and a drawer 3. The cavity 2 has a cooking chamber inside. The drawer 3 is connected to the cavity 2 in a manner capable of moving back and forth within the cooking chamber. Rollers 46 are respectively disposed on the left and right sides of the drawer 3. The rollers 46 are in rolling contact with the bottom wall 24 of the cavity 2 and are capable of clearance fit or rolling contact with the side walls 22 of the cavity 2. The angle α between the rotation center axis (i.e., the rolling axis) of the rollers 46 and the horizontal plane is 0°-60°.

It should be noted that, in order to avoid ambiguity, the cavity 2 is generally provided with left and right side walls 22. Correspondingly, the left and right sides of the drawer 3 are provided with corresponding rollers 46. In the present application, the rollers 46 being capable of contacting the side walls 22 means that the rollers 46 are capable of contacting the side walls 22 adjacent thereto, such as the left roller contacting the left side wall.

Thus, the present application, based on existing drawer-type microwave ovens, only provides two rollers 46 without requiring any modification to the existing cavity 2 structure. By only adjusting the arrangement of the rollers 46 such that the rollers 46 can be in rolling contact with the bottom wall 24 while also being capable of clearance fit or rolling contact with the side walls 22, this ensures the normal pulling process of the drawer 3 on the one hand, and on the other hand enables the cavity 2 itself to provide limiting action on the rollers 46 and the drawer 3 in the left-right direction. Compared with the prior art, this eliminates the need for rollers 46 with vertical rolling axes, reduces the number of rollers 46, and can still achieve limiting of the drawer 3 in the left-right direction, preventing the drawer 3 from swaying left and right during the pulling process.

Correspondingly, the present application, while equally being able to solve the problem of left-right swaying of the drawer 3, can effectively reduce the number of rollers compared with the prior art, reduces the structural complexity of moving components on the drawer 3, and is conducive to reducing the assembly difficulty of the drawer 3 within the cooking chamber.

The drawer 3 includes a door body 5, a carrier frame 8, and a slide rail assembly. The front portion of the carrier frame 8 is connected to the door body 5. Rollers 46 are respectively disposed on both sides of the rear portion of the carrier frame 8. The drawer 3 is slidably connected to the cavity 2 through the slide rail assembly, thereby further improving the smoothness of the drawer 3 during the pulling process.

A mounting plate 451 is disposed at the rear portion of the carrier frame 8. The rollers 46 are connected to the mounting plate 451 in a rotatable manner. The mounting plate 451 can be integrally stamped and formed during the processing of the carrier frame 8, without requiring additional provision or assembly, which is conducive to simplifying the overall structure of the carrier frame 8 and the drawer 3.

The ratio of the axial width K of the roller 46 to the radial diameter of the roller 46 is b, where b≥1.

The roller 46 is configured to be wider, which on one hand increases the contact area between the roller 46 and the bottom wall 24, improving the motion stability of the roller 46 and the drawer 3, and on the other hand enables the roller 46 to be close to the side wall 22, or even have a certain degree of contact with the side wall 22, ensuring the limiting function of the cavity 2 on the roller 46 and the drawer 3 in the left-right direction, preventing the drawer 3 from swaying left and right during the pulling process, and improving the safety and system stability of the drawer 3 throughout the entire opening and closing process.

Regarding the specific configuration of the roller 46, the present application proposes the following forms.

### Form One

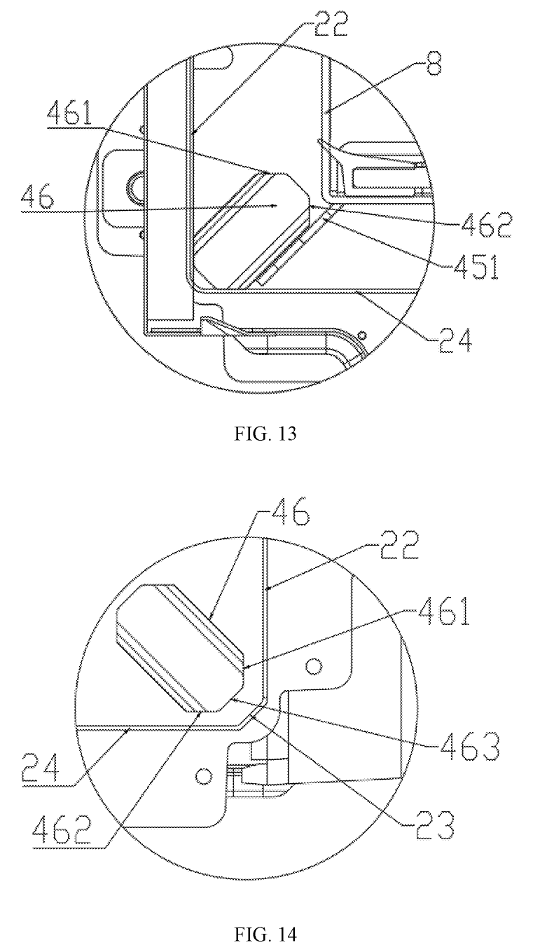

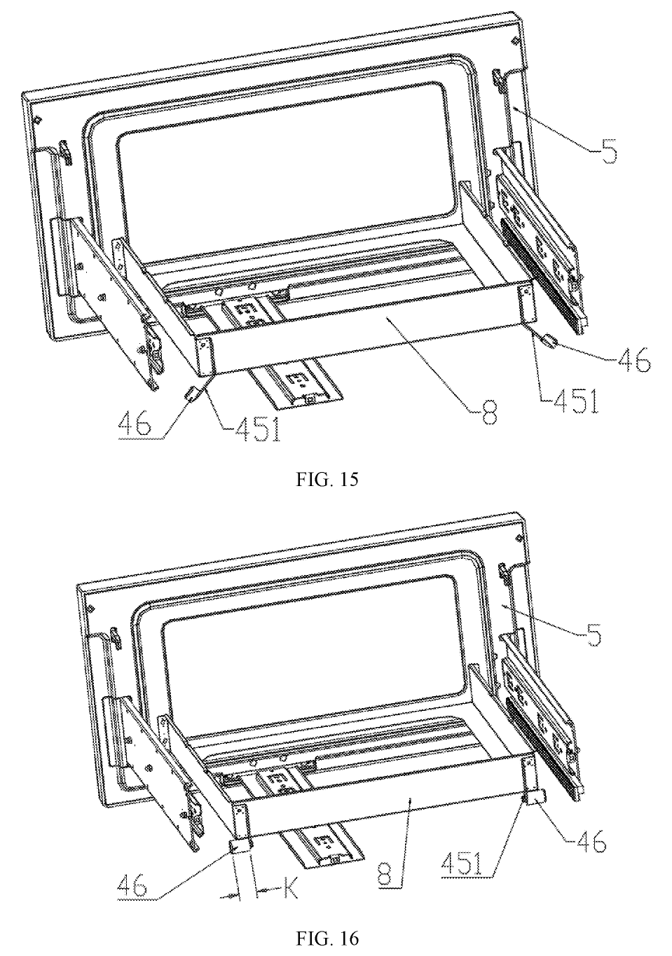

As shown in FIG. 13, in the direction of the rotation center axis of the roller 46, a first conical surface 461 is provided on one side of the roller 46, and a second conical surface 462 is provided on the other side. The first conical surface 461 is in rolling contact with the side wall 22, and the second conical surface 462 is in clearance fit or rolling contact with the bottom wall 24. The sum of the cone angle of the first conical surface 461 and the cone angle of the second conical surface 462 is 180°, or in other words, the sum of the half-cone angle of the first conical surface 461 and the half-cone angle of the second conical surface 462 is 90°.

Wherein, to avoid unnecessary spatial interference, both the first conical surface 461 and the second conical surface 462 are of a frustum type. Of course, if the space is appropriately configured, they may also be of a conventional cone type.

Preferably, in the case of Form One, the angle α between the rotation center axis (i.e., the rolling axis) of the roller 46 and the horizontal plane is 30°-60°, preferably α is 45°, to avoid excessive tilting of the roller 46, so as to ensure the stability of the roller 46 during operation, while avoiding excessive component forces on the roller 46 itself and the corresponding roller 46 assembly structure (carrier frame 8, mounting plate 451).

On this basis, as shown in FIG. 14, the present application makes structural improvements to the connection between the bottom wall 24 and the side wall 22.

A transition inclined surface 23 is provided between the bottom wall 24 and the side wall 22. The wheel peripheral surface 463 of the roller 46 is in rolling contact with the transition inclined surface 23. Correspondingly, the transition inclined surface 23 is parallel to the rotation center axis of the roller 46. Thus, on the basis of the cooperation between the conical surfaces on both sides of the roller 46 and the bottom wall 24 and the side wall 22, by further providing the transition inclined surface 23 to support the wheel peripheral surface 463 of the roller 46, on one hand, it prevents part of the structure of the roller 46 from being in a suspended state, which is beneficial to improving the force distribution of the roller 46, and on the other hand, it increases the contact area between the roller 46 and the cavity 2, which is beneficial to ensuring smooth rolling of the roller 46 and improving the motion stability of the drawer 3 during the pulling and retracting process.

### Form Two

As shown in FIG. 16, the angle α between the rotation center axis (i.e., rolling axis) of the roller 46 and the horizontal plane is 0°, and the ratio of the axial width K of the roller 46 to the radial diameter of the roller 46 is b, where b≥1; the wheel peripheral surface 463 of the roller 46 is in rolling contact with the bottom wall 24, and the side surface of the roller 46 adjacent to the side wall 22 is in clearance fit or rolling contact with the side wall 22. Correspondingly, the roller 46 can be widened based on a conventional roller, for example: the ratio b of K to the radial diameter of the roller 46 is 1.5-3.5, for reference, and it is recommended to base on actual spatial dimensions.

That is, Form Two sets the rolling axis of the roller 46 horizontally and makes the roller 46 wider. On one hand, this increases the contact area between the roller 46 and the bottom wall 24, improving the movement stability of the roller 46 and the drawer 3. On the other hand, this enables the roller 46 to be close to the side wall 22, or even have a certain degree of contact with the side wall 22, ensuring the limiting effect of the cavity 2 on the roller 46 and the drawer 3 in the left-right direction, and preventing the drawer 3 from swaying left and right during the pulling process.

In this embodiment, step S47 includes the following steps:
S471: obtaining the angle α between the rotation center axis of the roller 46 and the horizontal plane;
S472: determining whether the angle α between the rotation center axis of the roller 46 and the horizontal plane is 0; if yes, proceeding to step S474; if no, proceeding to step S473;
S473: the speed v of the drawer 3 during the entire closing process is given by v = v0 - k1×α，wherein v0 represents a preset initial speed, k1 denotes a first preset coefficient;
S474: obtaining the ratio b of the axial width K of the roller 46 to the radial diameter of the roller 46;
S475: determining whether the ratio b of the axial width K of the roller 46 to the radial diameter of the roller 46 is ≥1; if yes, proceeding to step S476; if no, proceeding to step S477;
S476: the speed v of the drawer 3 during the entire closing process is given by v = v0 + k2×b，wherein k2 denotes a second preset coefficient;
S477: the speed v of the drawer 3 during the entire closing process is given by v = v0

S471~S473 dynamically adjust the closing speed of the drawer 3 based on the angle α between the rotation center axis of the roller 46 and the horizontal plane. When the angle α between the rotation center axis of the roller 46 and the horizontal plane is not 0, i.e., when the roller 46 is arranged in an inclined manner, the speed during the closing process is reduced to avoid the drawer 3 moving too fast and becoming uncontrollable due to the inclination, thereby improving the safety and stability of the drawer 3 throughout the entire closing process. S475~S477 dynamically adjust the closing speed of the drawer 3 based on the ratio b of the axial width K of the roller 46 to the radial diameter of the roller 46. When the ratio b of the axial width K of the roller 46 to the radial diameter of the roller 46 is ≥1, the speed during the closing process is increased, thereby improving the closing efficiency of the drawer 3 while ensuring the safety and stability of the drawer 3 throughout the entire closing process.

Steps S471~S477 are interrelated and inseparable. Through a dynamic speed adjustment mechanism, combined with the angle α between the rotation center axis of the roller 46 and the horizontal plane and the ratio b of the axial width K of the roller 46 to the radial diameter of the roller 46, intelligent control of the closing speed of the drawer 3 is achieved, which not only improves the safety and system stability of the drawer 3 throughout the entire closing process, but also improves the closing efficiency of the drawer 3.

In the present embodiment, step S48 comprises the following steps:
S481: acquiring the angle α between the rotation center axis of the roller 46 and the horizontal plane;
S482: determining whether the angle α between the rotation center axis of the roller 46 and the horizontal plane is 0; if yes, proceeding to step S484; if no, proceeding to step S483;
S483: the speed v of the drawer 3 throughout the entire opening process is given by v = v0 - k1×α;
S484: acquiring the ratio b of the axial width K of the roller 46 to the radial diameter of the roller 46;
S485: determining whether the ratio b of the axial width K of the roller 46 to the radial diameter of the roller 46 is ≥1; if yes, proceeding to step S486; if no, proceeding to step S487;
S486: the speed v of the drawer 3 throughout the entire opening process is given by v = v0 + k2×b;
S487: the speed v of the drawer 3 throughout the entire opening process is given by v = v0

S481~S483 dynamically adjust the opening speed of the drawer 3 based on the angle α between the rotation center axis of the roller 46 and the horizontal plane. When the angle α between the rotation center axis of the roller 46 and the horizontal plane is not 0, i.e., when the roller 46 is installed at an incline, the speed during the opening process is reduced to prevent the drawer 3 from moving too fast and losing control due to the inclination, thereby improving the safety and stability of the drawer 3 throughout the entire opening process. S484~S487 dynamically adjust the opening speed of the drawer 3 based on the ratio b of the axial width K of the roller 46 to the radial diameter of the roller 46. When the ratio b of the axial width K of the roller 46 to the radial diameter of the roller 46 is ≥1, the speed during the opening process is increased, thereby improving the opening efficiency of the drawer 3 while ensuring the safety and stability of the drawer 3 throughout the entire opening process.

Steps S481~S487 are interrelated and inseparable. Through a dynamic speed adjustment mechanism, combined with the angle α between the rotation center axis of the roller 46 and the horizontal plane and the ratio b of the axial width K of the roller 46 to the radial diameter of the roller 46, intelligent control of the opening speed of the drawer 3 is achieved, which not only improves the safety and system stability of the drawer 3 throughout the entire opening process, but also improves the opening efficiency of the drawer 3.

Specifically, the preset initial speed v0, the first preset coefficient k1, and the second preset coefficient k2 are all preset values and are not specifically limited.

In summary, the present application approaches the problem from two aspects: the control method of the drawer-type microwave oven and the structure of the drawer-type microwave oven, improving both the safety and the stability of the drawer 3 during the opening and closing processes.

The control method of a drawer-type microwave oven and the structure of a drawer-type microwave oven described in the present embodiment are interrelated and inseparable, improving both the safety and the stability of the drawer 3 during the opening and closing processes. In addition, the opening and closing efficiency of the drawer 3 is also improved, the service life of the drawer 3 and the motor is extended, and energy waste caused by frequent starting and stopping or speed changes is reduced.

Although the present disclosure is disclosed as above, the present disclosure is not limited thereto. Any person skilled in the art may make various changes and modifications without departing from the spirit and scope of the present disclosure. Therefore, the protection scope of the present disclosure shall be determined by the scope defined by the claims.

1. A control method for a drawer-type microwave oven, wherein the drawer-type microwave oven comprises an oven body, a drawer, and a motor, wherein the drawer is connected to the oven body, the motor is used to drive the drawer to move in a front-rear direction relative to the oven body, and only one door opening/closing button is provided on the oven body;
The control method comprises the following steps:
S1: powering on the drawer-type microwave oven;
S2: obtaining a pressing duration t1 of the door opening/closing button;
S3: determining whether the pressing duration t1 > a first preset time threshold T1; if yes, proceeding to step S4; if no, maintaining the current state;
S4: controlling the motor to open or close the drawer; controlling the motor to drive the drawer to move at a uniform speed throughout the entire opening and/or closing process.

2. A control method for a drawer-type microwave oven of claim 1, wherein step S2 comprises the following steps:
S21: determining whether a child lock is set; if yes, maintaining the current state; if no, proceeding to step S22;
S22: determining whether the door opening/closing button is pressed; if yes, proceeding to step S23; if no, resetting a timer to zero;
2S3. the timer starts timing;
2S4. acquiring the pressing duration t1 of the door opening/closing button.

3. The control method for a drawer-type microwave oven of claim 1, wherein step S4 comprises the following steps:
S41: setting the initial count of the counter to 0;
S42: determining whether the drawer is closed; if yes, proceeding to step S43; if no, proceeding to step S44;
S43: controlling the motor to open the drawer and setting the count of the counter to 0;
S44: determining whether the drawer is at the maximum door opening stroke; if yes, proceeding to step S45; if no, proceeding to step S46;
S45: controlling the motor to close the drawer and setting the count of the counter to 1;
S46: determining whether the count of the counter is 1; if yes, proceeding to step S47; if no, closing the drawer;
S47: closing the drawer;
S48: opening the drawer.

4. The control method for a drawer-type microwave oven of claim 1, wherein the value range of the first preset time threshold T1 is: [0.4, 10], and the unit of the first preset time threshold T1 is s.

5. The control method for a drawer-type microwave oven of claim 4, wherein the first preset time threshold T1 is 0.5s.

6. The control method for a drawer-type microwave oven of claim 1, wherein, said control method further comprises the following steps:
S5: determining whether a stop command is received, if yes, proceeding to step S8, if no, proceeding to step S6;
S6: obtaining the operation time t2 of the motor;
S7: determining whether the operation time t2 of the motor > a second preset time threshold T2, if yes, proceeding to step S8, if no, maintaining the current state;
S8: controlling the motor to stop moving.

7. The control method for a drawer-type microwave oven of claim 6, wherein the value range of the second preset time threshold T2 is: (0, 10], and the unit of the second preset time threshold T2 is s.

8. The control method for a drawer-type microwave oven of claim 3, wherein rollers are respectively provided on the left and right sides of the drawer, and step S47 comprises the following steps:
S471: acquiring an angle α between the rotation center axis of the roller and a horizontal plane;
S472: determining whether the angle α between the rotation center axis of the roller and the horizontal plane is 0; if yes, proceeding to step S474; if no, proceeding to step S473;
S473: the speed v of the drawer during the entire closing process is given by v = v0 - k1×α，wherein v0 represents a preset initial speed, k1 denotes a first preset coefficient;
S474: acquiring a ratio b of the axial width K of the roller to the radial diameter of the roller;
S475: determining whether the ratio b of the axial width K of the roller to the radial diameter of the roller ≥ 1; if yes, proceeding to step S476; if no, proceeding to step S477;
S476: the speed v of the drawer during the entire closing process is given by v = v0 + k2×b，wherein k2 denotes a second preset coefficient;
S477: the speed v of the drawer during the entire closing process is given by v = v0.

9. The control method for a drawer-type microwave oven of claim 8, wherein step S48 comprises the following steps:
S481: obtaining an angle α between the rotation center axis of the roller and a horizontal plane;
S482: determining whether the angle α between the rotation center axis of the roller and the horizontal plane is 0; if yes, proceeding to step S484; if no, proceeding to step S483;
S483: the speed v of the drawer during the entire opening process is given by v = v0 - k1×α;
S484: obtaining a ratio b of the axial width K of the roller to the radial diameter of the roller;
S485: determining whether the ratio b of the axial width K of the roller to the radial diameter of the roller ≥ 1; if yes, proceeding to step S486; if no, proceeding to step S487;
S486: the speed v of the drawer during the entire opening process is given by v = v0 + k2×b;
S487: the speed v of the drawer during the entire opening process is given by v = v0.

10. The drawer-type microwave oven, wherein the drawer-type microwave oven uses the control method for a drawer-type microwave oven of claim 1.

11. The drawer-type microwave oven of claim 10, wherein the oven body comprises a cavity, a sensing assembly is disposed on a front side of the cavity, and a trigger assembly is disposed on a rear side of the drawer; when the drawer moves to the maximum door opening stroke, the trigger assembly is capable of applying magnetic force to or projecting light onto the sensing assembly for triggering the sensing assembly.

12. The drawer-type microwave oven of claim 11, wherein the trigger assembly has a magnetic structure or a light source component, and the sensing assembly has a corresponding reed switch sensor or optocoupler sensor.

13. The drawer-type microwave oven of claim 10, wherein a locking slot is disposed on the oven body, a microswitch is disposed in the locking slot, the drawer comprises a door body, an elastic door hook is disposed on the door body, the elastic door hook comprises a hook portion, and engagement or disengagement of the hook portion with the locking slot causes the microswitch to be switched on or off.

14. The drawer-type microwave oven of claim 13, wherein an elastic member is disposed on the door body, one end of the elastic member is connected to the elastic door hook, and the other end of the elastic member is connected to the door body.

15. The drawer-type microwave oven of claim 11, wherein the cavity has a cooking chamber therein, the drawer is connected to the cavity in a manner capable of moving back and forth in the cooking chamber, rollers are respectively disposed on left and right sides of the drawer, the rollers are in rolling contact with a bottom wall of the cavity and are capable of being in clearance fit or rolling contact with a side wall of the cavity; an angle between a rotation center axis of the roller and a horizontal plane is α, where α is 0°-60°.

16. The drawer-type microwave oven of claim 15, wherein in a direction of the rotation center axis of the roller, a first conical surface is disposed on one side of the roller, and a second conical surface is disposed on the other side, the first conical surface is in rolling contact with the side wall, and the second conical surface is in clearance fit or rolling contact with the bottom wall.

17. The drawer-type microwave oven of claim 16, wherein α is 30°-60°.

18. The drawer-type microwave oven of claim 17, wherein a ratio of an axial width K of the roller to a radial diameter of the roller is b, where b≥1.

19. The drawer-type microwave oven of claim 18, wherein b is 1.5-3.5.
